(19) United States
(12) Patent Application Publication
(10) Pub. No.: US 2018/0241081 A1
(43) Pub. Date: Aug. 23, 2018

(54) ELECTROLYTE, FLEXIBLE ELECTRODE AND FLEXIBLE ELECTRONIC DEVICE

(71) Applicant: NATIONAL SYNCHROTRON RADIATION RESEARCH CENTER, Hsinchu (TW)

(72) Inventors: MING-JAY DENG, HSINCHU (TW); KUEIH-TZU LU, HSINCHU (TW); JIN-MING CHEN, HSINCHU (TW)

(21) Appl. No.: 15/437,929

(22) Filed: Feb. 21, 2017

(51) Int. Cl. H01M 10/0565; H01M 2/02; H01G 11/60; H01G 11/62; H01G 11/22

(52) U.S. Cl. CPC H01M 10/0565; H01M 2/0275; H01G 11/60; H01M 2220/30; H01G 11/22; H01M 2300/0085; H01G 11/62

(57) ABSTRACT

An electrolyte includes a lithium-containing quasi-ionic liquid and a gel. The lithium-containing quasi-ionic liquid includes an organic compound having at least one acylamino group, and a lithium salt. A flexible electrode includes the lithium-containing quasi-ionic liquid and the gel. The gel has a network structure, and the lithium-containing quasi-ionic liquid is sealed in the network structure. A flexible electronic device includes a flexible electronic component, and the flexible electrode is electrically connected to the flexible electronic component.

### TECHNICAL FIELD

The present disclosure relates to an electrolyte, a flexible electrode and a flexible electronic device, and more particularly, to an electrolyte including a lithium-containing quasi-ionic liquid and a gel, and a flexible electrode and a flexible electronic device using the electrolyte as a conductive medium.

### DISCUSSION OF THE BACKGROUND

Lightweight, wearable and flexible supercapacitors (SCs) have generated acute interest for energy storage use due to their potential applications in wearable/roll-up display, electronic paper, mobile phone, sensor networks, hand-held portable devices and artificial electronic skin. SCs provide energy density greater than that of a conventional capacitor, with faster charge/discharge rates and a cycle life longer than that of batteries. A free-standing and binder-free electrode with robust mechanical strength and large capacitance is a vital factor for flexible SCs. As some of the most promising devices for energy storage, solid-state SCs have attracted intensive research interest because of their outstanding properties such as great safety, great flexibility, ultrathin profile, high power density, light weight, and reduced environmental footprint, all of which offers great promise in the field of lightweight, portable and roll-up electronics. Solid-state SCs enable an entire device to be flexible, lightweight, thin, and compact, but, to fill the increasing energy demands for the next-generation portable electronic devices, the energy density of solid-state SCs must be further improved within confined areas or spaces. Conductive paper electrodes have attracted much interest for the development of planar wearable SCs. Cellulose paper is a general type of cheap and abundant material having outstanding flexibility. The porous and natural rough surfaces of paper are perfect for energy-storage devices, in which high surface roughness is advantageous for the handling of ions and electrons. Paper is an insulator, however, which presents limitations. To improve the conductivity of paper, carbon nanotubes can be coated on the surface of the paper with a solution-based method, but such method requires environmentally destructive chemicals and complicated processes, and carbon nanotubes remain prohibitively expensive.

This Discussion of the Background section is provided for background information only. The statements in this Discussion of the Background are not an admission that the subject matter disclosed in this Discussion of the Background section constitutes prior art to the present disclosure, and no conductive paper electrodes, electrochemical capacitors or manufacturing methods described in this Discussion of the Background section may be used as an admission that any conductive paper electrode, electrochemical capacitor or manufacturing method of this application, including the conductive paper electrode, electrochemical capacitor and manufacturing method described in this Discussion of the Background section, constitutes prior art to the present disclosure.

### SUMMARY

One aspect of the present disclosure provides an electrolyte, a flexible electrode and a flexible electronic device.

An electrolyte according to some embodiments of the present disclosure includes a lithium-containing quasi-ionic liquid and a gel. The lithium-containing quasi-ionic liquid includes an organic compound having at least one acylamino group, and also includes a lithium salt.

In some embodiments, the lithium salt is characterized as LiX, where X includes ClO₄⁻, SCN⁻, PF₆⁻, B(C₂O₄)₂⁻, N(SO₂CF₃)₂⁻, CF₃SO₃⁻, or a combination thereof.

In some embodiments, the gel includes polyvinyl alcohol (PVA).

In some embodiments, the gel has a network structure, and the lithium-containing quasi-ionic liquid is sealed in the network structure.

In some embodiments, a weight ratio of the lithium-containing quasi-ionic liquid to the gel is between about 1:4.5 and about 4:1.

In some embodiments, the electrolyte is transparent.

In some embodiments, the electrolyte is flexible.

A flexible electrode according to some embodiments of the present disclosure includes a lithium-containing quasi-ionic liquid and a gel. The lithium-containing quasi-ionic liquid includes an organic compound having at least one acylamino group, and a lithium salt. The gel has a network structure, wherein the lithium-containing quasi-ionic liquid is sealed in the network structure.

In some embodiments, the lithium salt is characterized as LiX, where X includes ClO₄⁻, SCN⁻, PF₆⁻, B(C₂O₄)₂⁻, N(SO₂CF₃)₂⁻, CF₃SO₃⁻, or a combination thereof.

In some embodiments, the organic compound comprises acetamide, urea, methylurea (NMU), 2-oxazolidinone (OZO), ethyleneurea, 1,3-dimethylurea DMU, or a combination thereof.

In some embodiments, the gel includes polyvinyl alcohol (PVA).

In some embodiments, a weight ratio of the lithium-containing quasi-ionic liquid to the gel is between about 1:4.5 and about 4:1.

In some embodiments, the flexible electrode is transparent.

A flexible electronic device according to some embodiments of the present disclosure includes a flexible electronic component, and a flexible electrode electrically connected to the flexible electronic component. The flexible electrode includes a lithium-containing quasi-ionic liquid and a gel. The lithium-containing quasi-ionic liquid includes an organic compound having at least one acylamino group, and a lithium salt. The gel has a network structure, wherein the lithium-containing quasi-ionic liquid is sealed in the network structure.

In some embodiments, the lithium salt is characterized as LiX, where X includes ClO₄⁻, SCN⁻, PF₆⁻, B(C₂O₄)₂⁻, N(SO₂CF₃)₂⁻, CF₃SO₃⁻, or a combination thereof.

In some embodiments, the organic compound includes acetamide, urea, methylurea (NMU), 2-oxazolidinone (OZO), ethyleneurea, 1,3-dimethylurea DMU, or a combination thereof.

In some embodiments, the gel includes polyvinyl alcohol (PVA).

In some embodiments, the flexible electrode is transparent.

In some embodiments, a weight ratio of the lithium-containing quasi-ionic liquid to the gel is between about 1:4.5 and about 4:1.

The foregoing has outlined rather broadly the features and technical advantages of the present disclosure in order that the detailed description of the disclosure that follows may be better understood. Additional features and advantages of the disclosure will be described hereinafter, and form the subject of the claims of the disclosure. It should be appreciated by those skilled in the art that the conception and specific embodiment disclosed may be readily utilized as a basis for modifying or designing other structures or processes for carrying out the same purposes as those of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures, and:

FIG. 1 is a schematic view of an electrolyte in accordance with some embodiments of the present disclosure;

FIG. 2 lists examples of chemical formula of the organic compound constituting the electrolyte in accordance with some embodiments of the present disclosure;

FIG. 3A shows CV curves of MNNGP electrodes in PVA/urea-LiClO₄, Na₂SO₄ and urea-LiClO₄ electrolytes at scan rate 5 mV/s, respectively;

FIG. 3B shows CV curves of the MNNGP electrode measured in PVA/urea-LiClO₄ at varied scan rates 5 mV/s, 25 mV/s, 50 mV/s, 100 mV/s, 200 mV/s and 500 mV/s, respectively;

FIG. 3C shows galvanostatic charge/discharge curves of MNNGP electrode measured in PVA/urea-LiClO₄ at varied current densities 2 A/g, 5 A/g, 10 A/g, 20 A/g, 30 A/g and 50 A/g, respectively;

FIG. 3D shows CV curves of MNNGP electrode measured in PVA/urea-LiClO₄ at varied operating temperatures 27° C., 60° C., 90° C. and 110° C., respectively;

FIG. 3E shows a plot of Csp of the MNNGP electrode measured at varied temperature versus scan rate;

FIG. 4A shows Mn K-edge XANES spectra of MNNGP electrode recorded in urea-LiClO₄/PVA electrolyte at 90° C. under various applied potentials;

FIG. 4B shows a variation of the Mn oxidation state in urea-LiClO₄/PVA at 27° C., 60° C. and 90° C. with applied potential;

FIG. 5 shows a variation of ratio of capacitance retained versus cycle number of MNNGP electrode in urea-LiClO₄/PVA;

FIG. 6 is a schematic view of a flexible electrode in accordance with some embodiments of the present disclosure; and

FIG. 7 is a schematic view of a flexible electronic device in accordance with some embodiments of the present disclosure.

### DETAILED DESCRIPTION

The following description of the disclosure accompanies drawings, which are incorporated in and constitute an electrolyte, a flexible electrode, and a flexible electronic device of this specification, and illustrate embodiments of the disclosure, but the disclosure is not limited to the embodiments. In addition, the following embodiments can be properly integrated to complete another embodiment.

References to “one embodiment,” “an embodiment,” “exemplary embodiment,” “some embodiments,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

The present disclosure is directed to an electrolyte including a mixture of a lithium-containing quasi-ionic liquid and a gel. The lithium-containing quasi-ionic liquid is located in the space of a network structure formed from the flexible gel, and thus can provide conductivity in a flexible state. The present disclosure is further directed to a flexible electrode formed from the above electrolyte, which exhibits high flexibility. The following description is also directed to a flexible electronic device including a flexible electronic component and the above flexible electrode, as discussed below.

In order to make the present disclosure completely comprehensible, detailed steps and structures are provided in the following description. Obviously, implementation of the present disclosure does not limit special details known by persons skilled in the art. In addition, known structures and steps are not described in detail, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed description, and is defined by the claims.

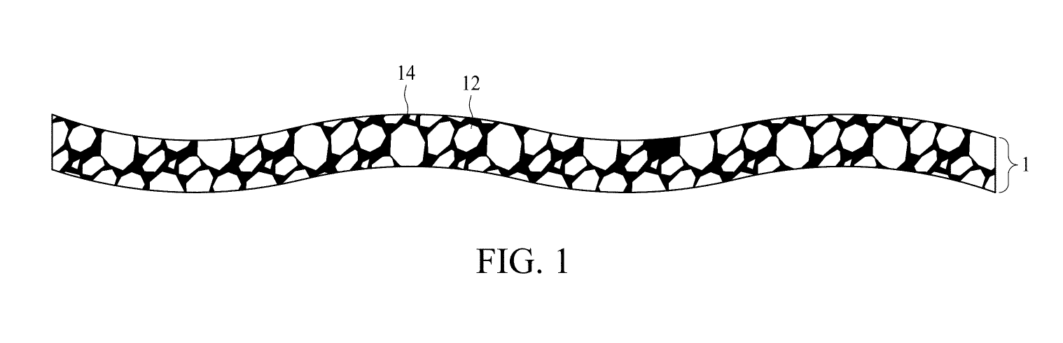

FIG. 1 is a schematic view of an electrolyte in accordance with some embodiments of the present disclosure. The electrolyte 1 includes a lithium-containing quasi-ionic liquid 12 and a gel 14. The electrolyte 1 is transparent. The lithium-containing quasi-ionic liquid 12 includes an organic compound and a lithium salt. In some embodiments, the organic compound has at least one acylamino group, which is a functional group having a carbon atom double bonded with an oxygen atom, and single bonded with a nitrogen atom.

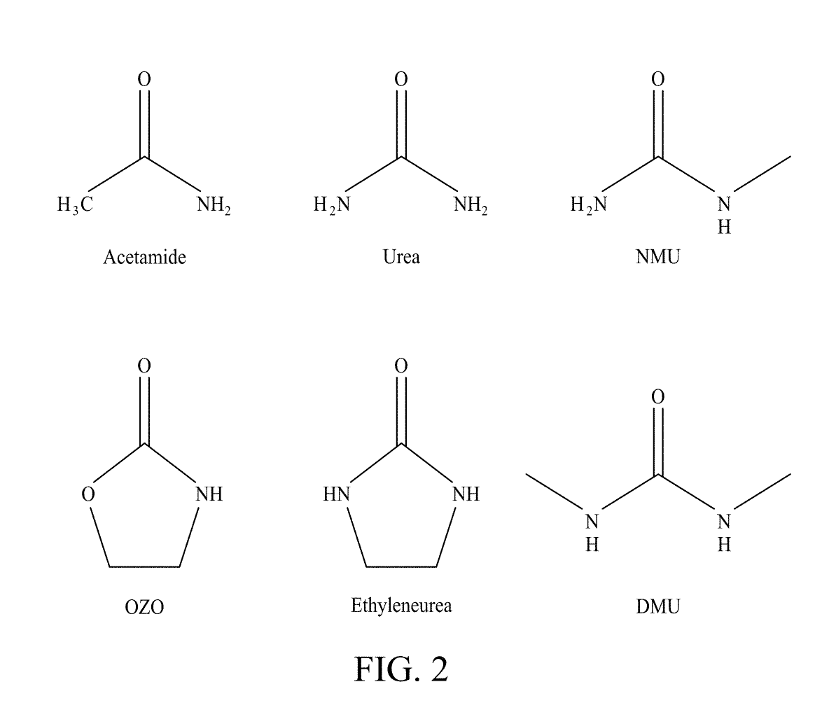

As shown in FIG. 2, the selection of the organic compound includes, but is not limited to, acetamide, urea, methylurea (NMU), 2-oxazolidinone (OZO), ethyleneurea, 1,3-dimethylurea DMU, the like, or a combination thereof. The above organic compound may include cyclic compounds, such as OZO or ethyleneurea, or acyclic compounds, such as acetamide, urea, NMU, or DMU. The above organic compound is commercially ready, does not require any complex synthesis or purification processes, and is therefore lower in cost.

The lithium salt in some embodiments is characterized as LiX, where Li is lithium, and X includes ClO₄⁻, SCN⁻, PF₆⁻, B(C₂O₄)₂⁻, N(SO₂CF₃)₂⁻, CF₃SO₃⁻, the like, or a combination thereof. LiN(SO₂CF₃)₂ is also known as lithium bis(trifluoromethylsulfonyl)imide (LiTFSI). In some embodiments, examples of the ranges of molar ratios (ratio of lithium salt to the organic compound) of the lithium-containing quasi-ionic liquid are listed in Table 1.

TABLE 1

| Lithium Salt:Organic Compound | Range of Molar Ratios |
|---|---|
| LiClO₄:acetamide | 1:4.2~1:5.2 |
| LiClO₄:urea | 1:3.1~1:4.1 |
| LiClO₄:ethyleneurea | 1:4.2~1:5.2 |
| LiClO₄:OZO | 1:4.2~1:4.5 |
| LiClO₄:DMU | 1:4.2 |
| LiClO₄:NMU | 1:3.1~1:4.1 |
| LiSCN:OZO | 1:4.2~1:6.2 |
| LiSCN:acetamide | 1:4.2~1:6.2 |
| LiSCN:ethyleneurea | 1:4.2~1:5.2 |
| LiSCN:DMU | 1:4.2 |
| LiSCN:NMU | 1:3.2~1:4.2 |
| LiTFSI:acetamide | 1:4.2~1:6.2 |
| LiTFSI:urea | 1:3.2~1:4.2 |
| LiTFSI:OZO | 1:3.2~1:6.2 |
| LiTFSI:ethyleneurea | 1:4.2 |
| LiPF₆:acetamide | 1:4.2~1:6.2 |
| LiPF₆:urea | 1:3.2~1:4.2 |
| LiPF₆:OZO | 1:4.2~1:6.2 |
| LiPF₆:ethyleneurea | 1:4.2~1:5.2 |

In some embodiments, the gel 14 includes a water-soluble gel such as polyvinyl alcohol (PVA) or the like.

In an exemplary embodiment, the lithium-containing quasi-ionic liquid includes urea-LiClO₄ ionic liquid, and the gel includes PVA. An example of preparation for the electrolyte 1 is illustrated as follows: Urea-LiClO₄ ionic liquid with molar ratio 4:1 is prepared from urea (Acros Inc., 95+%) and LiClO₄ (Acros Inc., AP). Next, the PVA/urea-LiClO₄ quasi-ionic liquid gel is prepared by mixing urea-LiClO₄ ionic liquid (5 g) and polyvinyl alcohol gel (PVA, 5 g) and heated at 110° C. for 1 hour under vigorous stirring until a homogeneous sticky solution is formed. The solution is cooled at room temperature, and the solution becomes a clear and transparent gel. The organic compound, the lithium salt and the gel are stable at room temperature and are not sensitive to water and light, and thus the electrolyte 1 can be prepared at room temperature and in a water-containing environment.

The lithium-containing quasi-ionic liquid 12 including the organic compound and the lithium salt is conductive and configured as electrolyte. The gel 14 such as PVA gel has a network structure, and the lithium-containing quasi-ionic liquid 12 is sealed in the network structure, which allows the lithium-containing quasi-ionic liquid 12 to travel in the space of the network structure and provides conductivity. The electrolyte 1 can have a range of properties, and the physical properties of the gel 14 can be modified by, for example, adjusting the ratio of the gel 14 to the lithium-containing quasi-ionic liquid 12. When the ratio of the gel 14 to the lithium-containing quasi-ionic liquid 12 is higher, the electrolyte 1 is softer and more flexible; when the ratio of the gel to the lithium-containing quasi-ionic liquid is lower, the electrolyte 1 is harder. In some embodiments, the weight ratio of the lithium-containing quasi-ionic liquid 12 to the gel 14 is, but not limited to be, in a range of from about 1:4.5 to about 4:1. Consequently, the form of the electrolyte 1 can be modified by, for example, adjusting the ratio of the gel to the lithium-containing quasi-ionic liquid.

In the description, all electrochemical tests were measured with the AUTOLAB workstation. The specific capacitance of cycle voltammetry (CV) and charge/discharge cycle is calculated as follows:

Csp=Qm/ΔV (1)

Csp=IΔt/ΔVw (2)

in which Qm is the specific voltammetric charge (based on Mn oxide mass) integrated from CV, ΔV is the scanning range (i.e., 0.8V×2), I is applied current density (2 A/g), w is Mn oxide mass, and Δt is duration of discharge cycling. With charge-discharge curves based on two electrode systems, Csp is specific capacitance of symmetric supercapacitor, and energy density (E) and power density (P) are calculated from chronopotentiometric curves according to equations (3) and (4):

E=½CspΔV₂ (3)

P=E/Δt (4)

Where Δt is time to discharge, and ΔV is cell voltage (i.e., 2.0V).

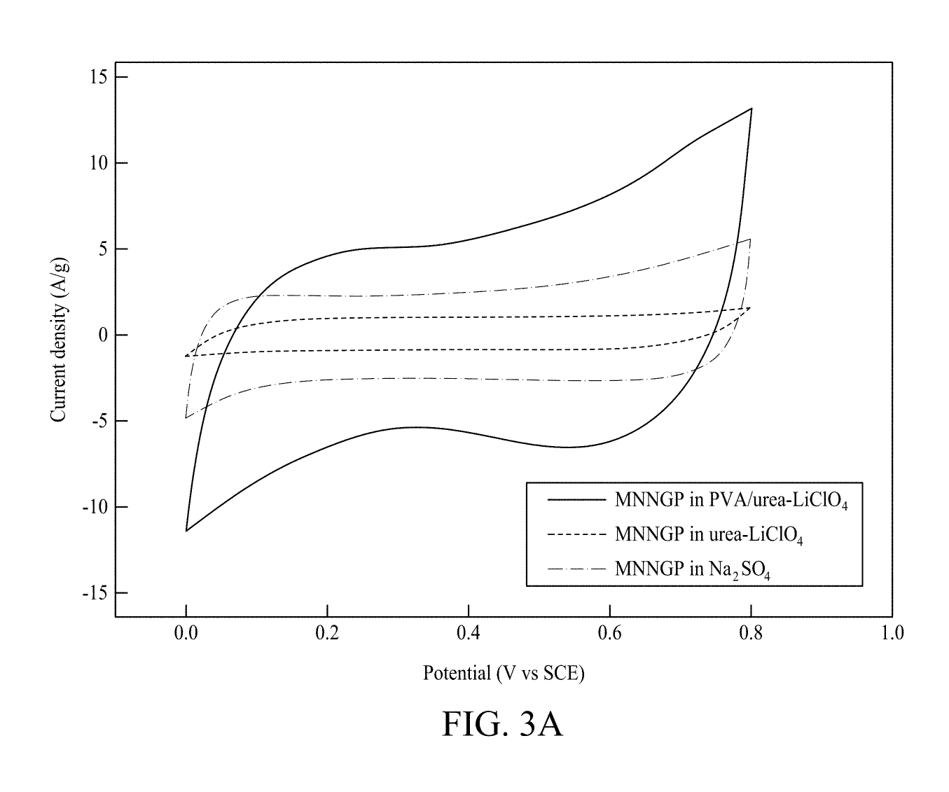

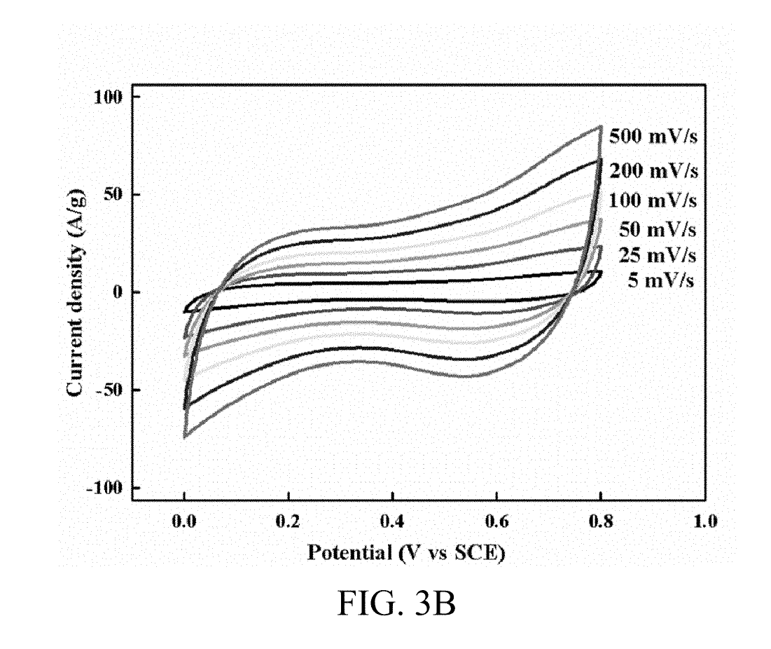

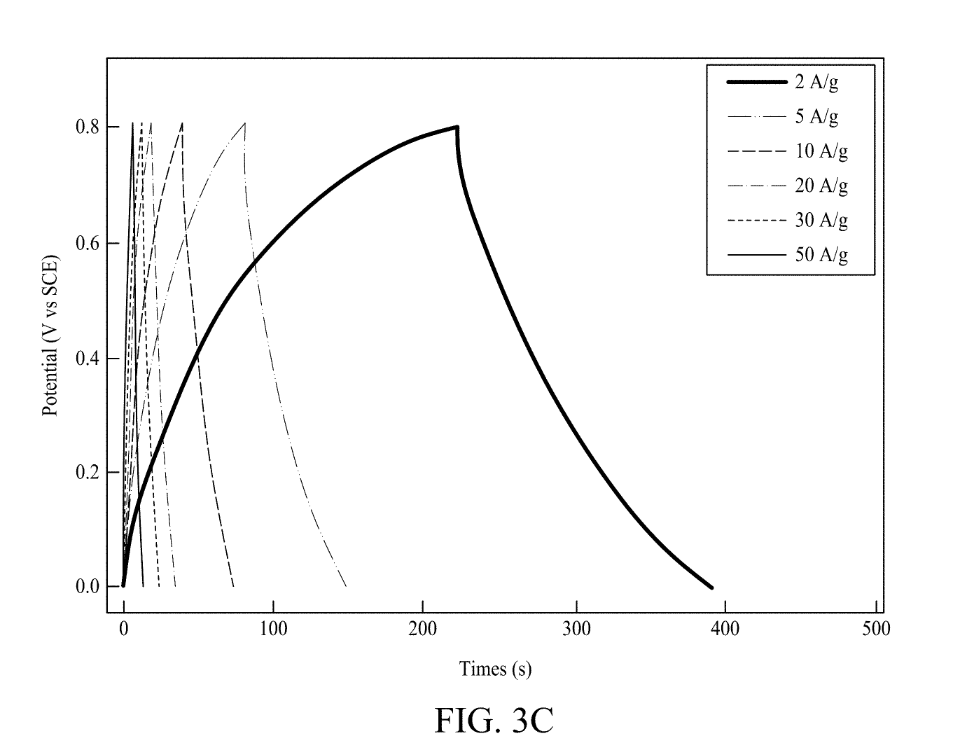

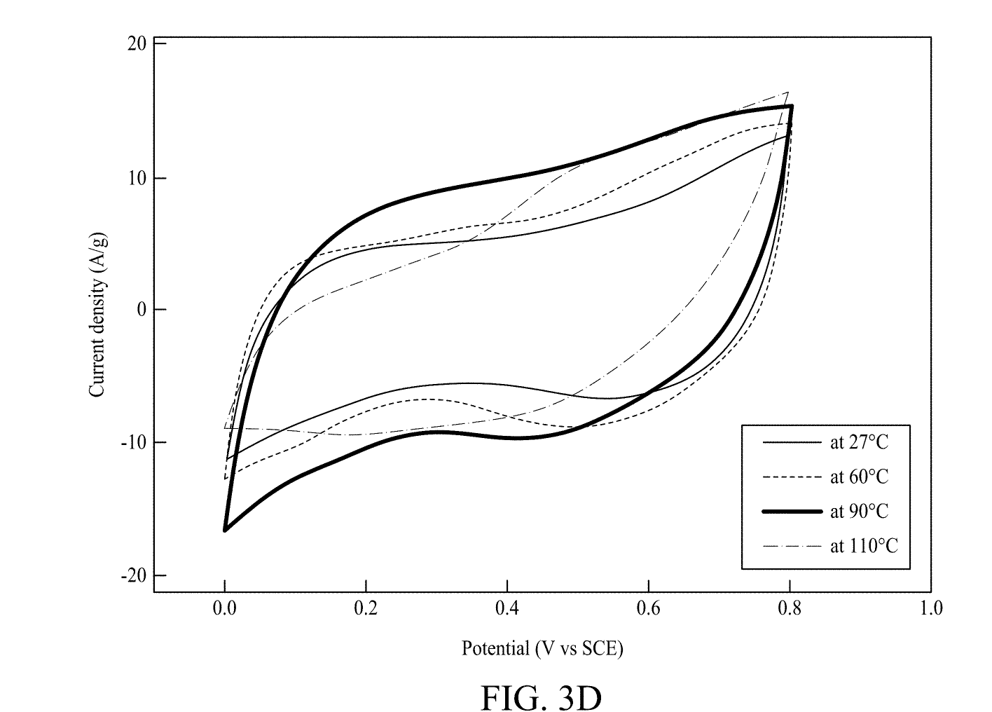

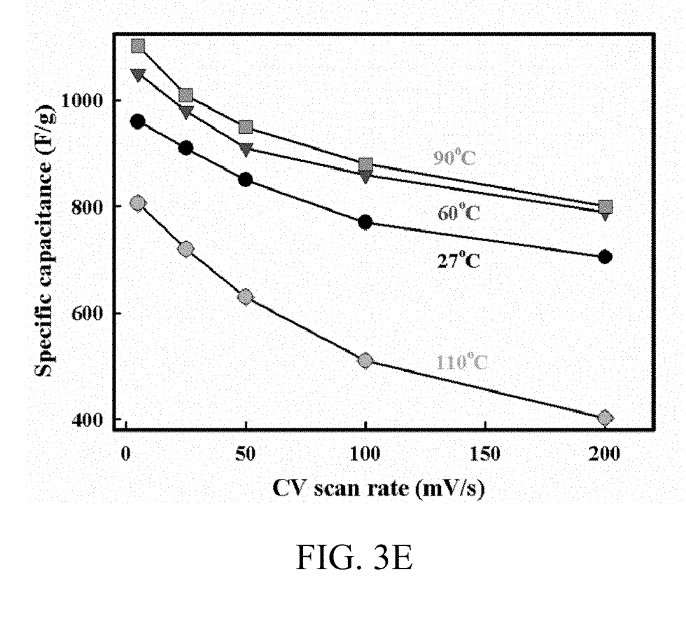

The electrochemical properties of a three electrode cell are studied in Na₂SO₄ aqueous (0.5 M), urea-LiClO₄ ionic liquid electrolyte and urea-LiClO₄/PVA quasi-ionic liquid electrolyte, respectively. The conductivity data of urea-LiClO₄/PVA (10 mS/cm) are greater than those of urea-LiClO₄/PVA (0.1 mS/cm) at 27° C. Urea-LiClO₄ and PVA can form a complex system. FIG. 3A shows the supercapacitive behavior of Mn oxide nanofiber/Ni-nanotube/graphite(carbon)/paper (MNNGP) electrode electrodes in aqueous Na₂SO₄, urea-LiClO₄ ionic liquid, and urea-LiClO₄/PVA gel electrolyte. The enclosed area of the CV curve in urea-LiClO₄/PVA is larger than that of Na₂SO₄ and urea-LiClO₄, respectively, which indicates a superior capability to store charge of MNNGP in urea-LiClO₄/PVA.

The calculated capacitances of the MNNGP in urea-LiClO₄/PVA, Na₂SO₄, and urea-LiClO₄ are 960 F/g, 600 F/g, and 220 F/g, respectively. Csp of MNNGP electrodes in urea-LiClO₄/PVA is also much greater than those of MnO2 nanobar (625 F/g), MnO2 hierarchical tubular (315 F/g), amorphous porous Mn₃O₄ (432 F/g), and graphite/PEDOT/MnO₂ composites (264 F/g). FIG. 3B shows that response current of MNNGP electrode in urea-LiClO₄/PVA increases along with the scan rate. Even at 200 mV/s, the MNNGP electrodes in urea-LiClO₄/PVA achieve Csp as large as 700 F/g, which shows about 27% decay in Csp from about 5 mV/s to about 200 mV/s.

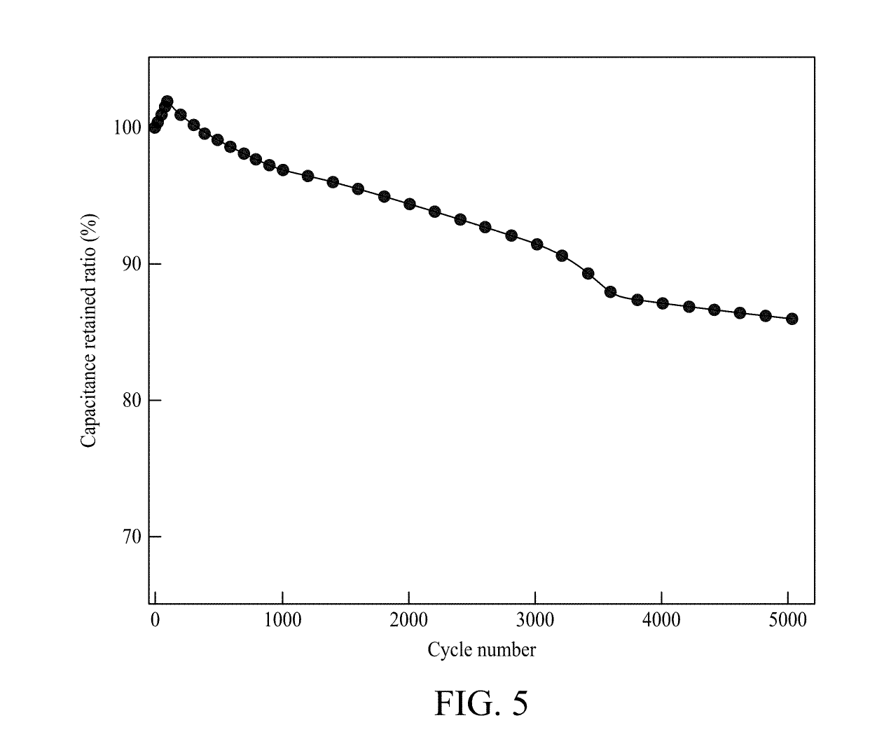

Galvanostatic charging/discharging curves of MNNGP electrodes in urea-LiClO₄/PVA at varied current density are shown in FIG. 3C, and they are all symmetrical. This evidence proves the excellent reversible reactions and great pseudocapacitive properties of MNNGP electrodes in urea-LiClO₄/PVA. FIG. 3D compares the CV of the MNNGP electrodes in urea-LiClO₄/PVA at operating temperatures ranging from 27° C. to 110° C. The data shows that the CV curve area in urea-LiClO₄/PVA at 60° C. and 90° C. are larger than those obtained at 27° C. It is worth noting that CV curves usually have the sloping property at high temperatures that might be attributed to (i) MnO₂ layer passivation or (ii) pseudocapacitive dedication (MnO₂ layer) occurring more at high temperatures than at low temperatures. Csp measured in urea-LiClO₄/PVA at 27° C., 60° C., 90° C., and 110° C. are 960 F/g, 1050 F/g, 1100 F/g, and 800 F/g, respectively. Csp of the MNNGP electrode measured in urea-LiClO₄/PVA at varied operating temperatures is plotted versus scan rate (5 mV/s-200 mV/s) in FIG. 3E. The results exhibit an excellent pseudocapacitive performance of MNNGP electrodes and urea-LiClO₄/PVA electrolyte system at high temperatures. It also indicates great kinetic performance and reactivity of MNNGP electrodes in urea-LiClO₄/PVA at temperatures up to 90° C. To further evaluate the stability of the MNNGP electrodes in urea-LiClO₄/PVA at various operating temperatures, the cycle life for 5000 cycles is tested at 25 mV/s. FIG. 5 shows a variation of capacitance retained ratio versus cycle number of MNNGP electrode in urea-LiClO₄/PVA. As shown in FIG. 5, only approximately 15% capacitance loss at 90° C. after 5000 cycles in urea-LiClO₄/PVA is observed. The gradually increasing capacitance during the first 100 cycles might be related to the electrode wetting/activation procedure in urea-LiClO₄/PVA. The results confirm the great cycle-life stability of the MNNGP electrode in urea-LiClO₄/PVA at high-temperature. The improved electrochemical performance of the MNNGP electrodes in urea-LiClO₄/PVA electrolyte is attributed to Li(urea)ₙ⁺ ions from electrolyte as the working ions insert/desert into/from the electrode and lead to great oxidation-state change.

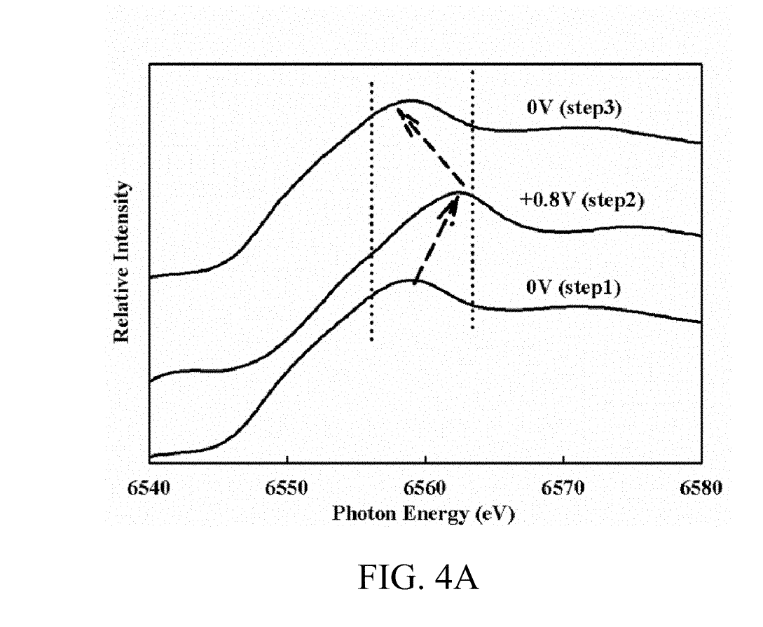

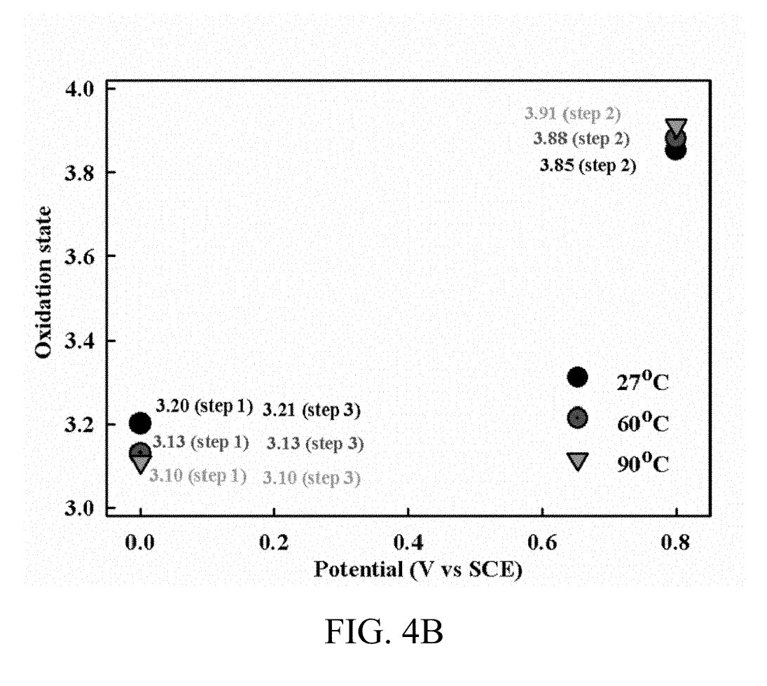

To illustrate the oxidation-state change of MNNGP electrode in urea-LiClO₄/PVA and the energy storage mechanism at varied operating temperatures during charge/discharge cycles, the chemical state change with different applied potentials by in situ Mn K-edge XAS is investigated. Experimental results show XANES spectra of MNNGP electrode in urea-LiClO₄/PVA at 90° C. recorded at applied potentials varied in this sequence: +0V, then +0.8V, and finally returning to +0V. A rising edge of Mn K-edge spectra of MNNGP altered to increasing energy with enhanced potential, and came back almost to the original state as the potential was reversed. An absorption threshold energy (E0), which is obtained from the first inflection point of the edge, is associated with transition-metal oxidation states. On the basis of E0 derived from XANES in FIG. 4A, Mn oxidation states of MNNGP electrode in urea-LiClO₄/PVA at varied temperatures is established and displayed in FIG. 4B. (MnO(II), Mn₂O₃ and MnO₂ are researched as reference samples.) The oxidation-state changes at 27° C., 60° C. and 90° C. are, very notably, approximately 0.81 each, which is greater than that in other published findings of only around ˜0.4, where an ideal value is 1. This effect implies a great ionic/electronic conductivity for MNNGP electrode in urea-LiClO₄/PVA electrolyte system at high temperature and a continuous and reversible Mn³⁺/Mn^{4|} reaction of MNNGP occurring in urea-LiClO₄/PVA that promotes the high performance noticed in FIGS. 3 and 4.

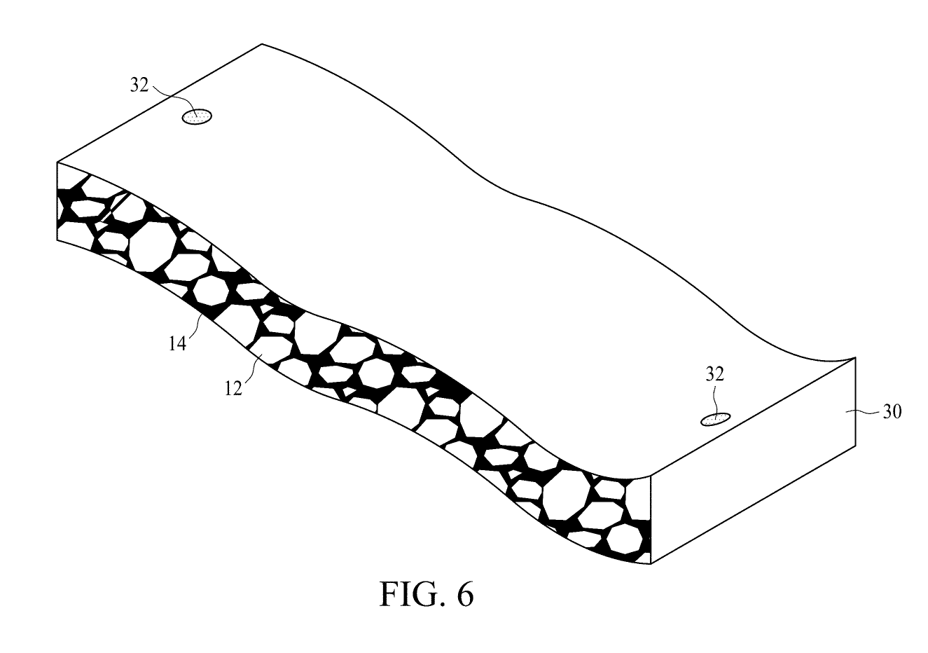

The above electrolyte is proven to have good conductivity, and can be individually configured as a flexible electrode. FIG. 6 is a schematic view of a flexible electrode in accordance with some embodiments of the present disclosure. As shown in FIG. 6, the flexible electrode 30 includes the lithium-containing quasi-ionic liquid 12 and the gel 14. The lithium-containing quasi-ionic liquid 12 includes the organic compound and the lithium salt. The materials, compositions and characteristics of the lithium-containing quasi-ionic liquid 12 and the gel 14 are detailed in the aforementioned descriptions, and are not redundantly described. In some embodiments, the flexible electrode 30 further includes one or more contact terminals 32 such as contact pads configured to create an electrical connection external to the flexible electrode 30. In some embodiments, the flexible electrode 30 is transparent. In some embodiments, the flexible electrode 30 can be applied to various flexible electronic devices, and configured as an electrode, a conductive layer or a conductive structure.

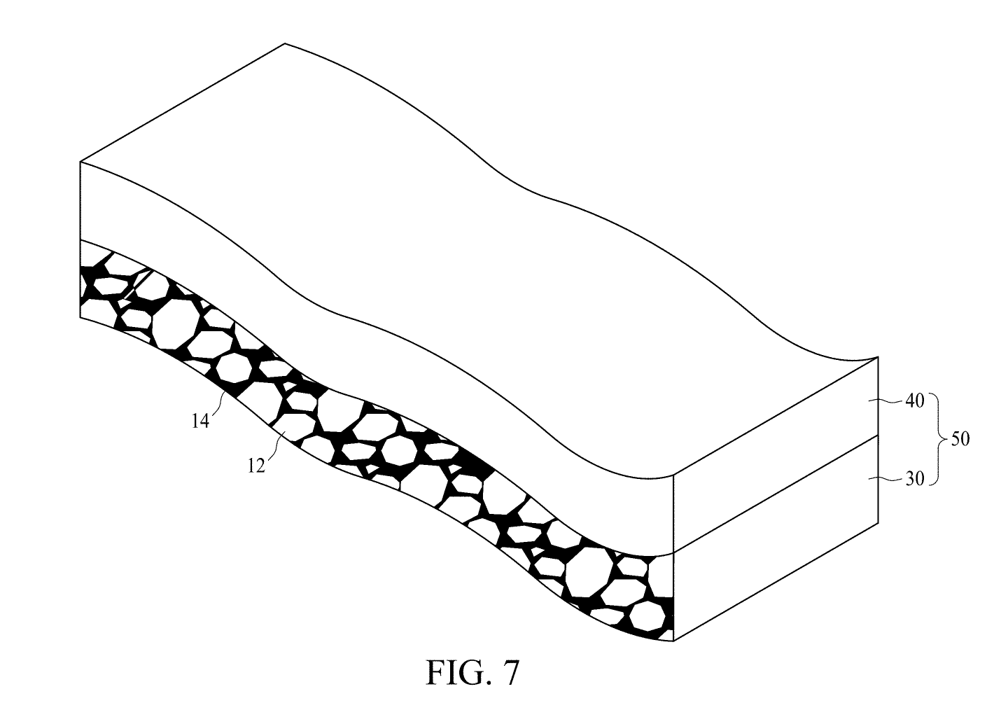

FIG. 7 is a schematic view of a flexible electronic device in accordance with some embodiments of the present disclosure. As shown in FIG. 7, the flexible electronic device 50 includes a flexible electronic component 40, and the flexible electrode 30 electrically connected to the flexible electronic component 40. The materials, compositions and characteristics of the flexible electrode 30 are detailed in the aforementioned descriptions, and are not redundantly described. In some embodiments, the flexible component 40 may include a flexible display panel, a flexible touch panel, a flexible sensor, a combination thereof, or the like.

In conclusion, the electrolyte, the flexible electrode and the flexible electronic device are advantageous due to light weight, flexibility, high conductivity, and sustainability. The electrolyte is stable at room temperature and is not sensitive to water, and thus can be prepared at room temperature and in a water-containing environment, which reduces manufacturing costs and simplifies processes. The electrolyte/electrode system can be assembled to a quasi-ionic liquid electrolyte and hybrid paper electrode system, which will be prospective for many flexible and wearable applications such as batteries, fuel cells, wearable/roll-up displays, electronic papers, touch devices, mobile phones, sensor networks, hand-held portable devices and artificial electronic skin.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same or equal if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” parallel can refer to a range of angular variation relative to 0° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ∓0.05°. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An electrolyte, comprising:
a lithium-containing quasi-ionic liquid, comprising:
an organic compound having at least one acylamino group; and
a lithium salt; and
a gel.

2. The electrolyte of claim 1, wherein the lithium salt is characterized as LiX, and where X comprises ClO₄⁻, SCN⁻, PF₆⁻, B(C₂O₄)₂⁻, N(SO₂CF₃)₂⁻, CF₃SO₃⁻, or a combination thereof.

3. The electrolyte of claim 1, wherein the organic compound comprises acetamide, urea, methylurea (NMU), 2-oxazolidinone (OZO), ethyleneurea, 1,3-dimethylurea DMU, or a combination thereof.

4. The electrolyte of claim 1, wherein the gel comprises polyvinyl alcohol (PVA).

5. The electrolyte of claim 1, wherein the gel has a network structure, and the lithium-containing quasi-ionic liquid is sealed in the network structure.

6. The electrolyte of claim 1, wherein a weight ratio of the lithium-containing quasi-ionic liquid to the gel is between about 1:4.5 and about 4:1.

7. The electrolyte of claim 1, wherein the electrolyte is transparent.

8. The electrolyte of claim 1, wherein the electrolyte is flexible.

9. A flexible electrode, comprising:
a lithium-containing quasi-ionic liquid, comprising:
an organic compound having at least one acylamino group; and
a lithium salt; and
a gel having a network structure, wherein the lithium-containing quasi-ionic liquid is sealed in the network structure.

10. The flexible electrode of claim 9, wherein the lithium salt is characterized as LiX, and where X comprises ClO₄⁻, SCN⁻, PF₆⁻, B(C₂O₄)₂⁻, N(SO₂CF₃)₂⁻, CF₃SO₃⁻, or a combination thereof.

11. The flexible electrode of claim 9, wherein the organic compound comprises acetamide, urea, methylurea (NMU), 2-oxazolidinone (OZO), ethyleneurea, 1,3-dimethylurea DMU, or a combination thereof.

12. The flexible electrode of claim 9, wherein the gel comprises polyvinyl alcohol (PVA).

13. The flexible electrode of claim 9, wherein a weight ratio of the lithium-containing quasi-ionic liquid to the gel is between about 1:4.5 and about 4:1.

14. The flexible electrode of claim 9, wherein the flexible electrode is transparent.

15. A flexible electronic device, comprising:
a flexible electronic component; and
a flexible electrode electrically connected to the flexible electronic component, wherein the flexible electrode comprises:
a lithium-containing quasi-ionic liquid, wherein the lithium-containing quasi-ionic liquid comprises:
an organic compound having at least one acylamino group; and
a lithium salt; and
a gel having a network structure, wherein the lithium-containing quasi-ionic liquid is sealed in the network structure.

16. The flexible electronic device of claim 15, wherein the lithium salt is characterized as LiX, and where X comprises ClO₄⁻, SCN⁻, PF₆⁻, B(C₂O₄)₂⁻, N(SO₂CF₃)₂⁻, CF₃SO₃⁻, or a combination thereof.

17. The flexible electronic device of claim 15, wherein the organic compound comprises acetamide, urea, methylurea (NMU), 2-oxazolidinone (OZO), ethyleneurea, 1,3-dimethylurea DMU, or a combination thereof.

18. The flexible electronic device of claim 15, wherein the gel comprises polyvinyl alcohol (PVA).

19. The flexible electronic device of claim 15, wherein the flexible electrode is transparent.

20. The flexible electronic device of claim 15, wherein a weight ratio of the lithium-containing quasi-ionic liquid to the gel is between about 1:4.5 and about 4:1.
